(19) United States
(12) Patent Application Publication
(10) Pub. No.: US 2019/0066731 A1
(43) Pub. Date: Feb. 28, 2019

(54) Enhanced Multi-Media Metadata Management and Playback Application

(71) Applicant: Jeff Jarrell, Ramsey, NJ (US)

(72) Inventor: Jeff Jarrell, Ramsey, NJ (US)

(21) Appl. No.: 16/110,673

(22) Filed: Aug. 23, 2018

Related U.S. Application Data
(60) Provisional application No. 62/549,754, filed on Aug. 24, 2017.

(51) Int. Cl. G11B 27/031; G06F 17/30; G11B 27/34

(52) U.S. Cl. CPC G11B 27/031; G06F 17/30058; H04N 21/2353; G11B 27/34; G06F 17/30887

(57) ABSTRACT

A system for curating a mix multi-media file made available over a computer network includes a server hosting a metadata management application configured to retrieve an original multi-media file from a network location over the computer network. The system further includes a curative electronic computing device communicably coupled with the server and metadata management application. The metadata application is programmed to receive one or more input commands from the curative electronic computing device and mark the original multi-media file with a first metadata marker and a second metadata marker based on the one or more input commands received from the curative electronic computing device.

### RELATED APPLICATION

The present application claims priority to U.S. Provisional Patent Application No. 62/549,754, filed on Aug. 24, 2017, which is herein incorporated by reference in its entirety for all that it shows, teaches, and suggests, without exclusion of any part thereof.

### TECHNICAL FIELD

The present disclosure is related generally to multi-media playback and, more particularly, to a system and method for enhanced multi-media content playback using a metadata management application over a computer network.

### BACKGROUND

Although the internet and the explosion of other such computer networks and community sites have led to increased opportunities for the sharing of audio, video and other such multi-media content, there is still no easy way for curators and other members of a community at large to easily condense down larger multi-media files in order to display just the content of interest. For example, a curator may use a computer based application to author a multi-media based tutorial or other such informational content that incorporates material from one or more different sources. In some cases, only a portion or segment of a particular source is desired to be used in the tutorial or other such informational content. As a result, the multi-media content may be broken down into smaller segments and pieced together that can be easily digested and repeated in order to better master the tutorial content.

While the present disclosure is directed to a system and method that can minimize or even eliminate certain shortcomings noted in or apparent from the above, it will be appreciated that such a benefit is neither a limitation on the scope of the disclosed principles nor of the attached claims, except to the extent expressly noted in the claims. Additionally, the discussion in this Background section is reflective of the inventors' own observations, considerations, and thoughts, and is not intended to catalog or summarize any item of prior art. As such, the inventors expressly disclaim this section as admitted or assumed prior art. Moreover, the identification or implication herein of a desirable course of action reflects the inventors' own observations and ideas, and therefore cannot be assumed to indicate an art-recognized desirability.

### SUMMARY

In keeping with an embodiment of the disclosed principles, a system for creating a multi-media file made available over a computer network is disclosed. The system may include a server hosting a metadata management application. The metadata management application may be configured to retrieve an original multi-media file from a network location on the computer network. The system may further include an electronic computing device communicably coupled with the server and the metadata management application. The metadata management application may be programmed to receive one or more input commands communicated from the curative electronic computing device. Furthermore, the metadata management application may be programmed to mark the original multi-media file with a first metadata marker and a second metadata marker based on the one or more input commands received from the curative electronic computing device.

In a further embodiment, a method of mixing a multi-media file using a metadata management application is disclosed. The method may include, accessing a server over a computer network, the server hosting the metadata management application. Moreover, the method may include identifying an original multi-media file at a network location over the computer network. Furthermore, the method may include inputting an URL of the original multi-media file into the metadata management application. The method may also include identifying a segment from the original multi-media file to be included in a mix multi-media file. Additionally, the method may include inputting a first input command into the metadata management application, the first input command marking the original multi-media file with a first metadata marker. Moreover, the method may further include inputting a second input command into the metadata management application, the second input command marking the original multi-media file with a second metadata marker. Other features and aspects of embodiments of the disclosed principles will be appreciated from the detailed disclosure taken in conjunction with the included figures.

In a further embodiment, a multi-media management application accessed by an electronic computing device to curate a mix multi-media file is disclosed. The application includes an application home page displayed by the electronic computing device, the application home page including a content viewing screen that displays an original multi-media file selected to be viewed and enhanced by the multi-media management application. The application may further include a multi-media editor bar displayed on the application home page, the multi-media editor bar includes an incut selector and an outcut selector, the incut selector and the outcut selector define a segment to be included in the mix multi-media file from the original multi-media file. A multi-media playback control may be further included on the application home page, the multi-media playback control includes a plurality of modes that control the playback of the content viewing screen. Furthermore, the application home page may include a multi-media profile editor including a profile text box for inputting a title for the segment defined from the original multi-media file.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a schematic view of an electronic computing device environment within which embodiments of the disclosed principles may be implemented;

FIG. 2 is a schematic view of an exemplary electronic computing device of the electronic computing device environment of FIG. 1 in accordance with an embodiment of the disclosed principles;

FIG. 3 is a flowchart of a process in accordance with an embodiment of the disclosed principles;

FIG. 4 is a screenshot in accordance with an embodiment of the disclosed principles;

FIG. 5 is an enlarged portion of the screenshot of FIG. 4 in accordance with an embodiment of the disclosed principles; and

FIG. 6 is an enlarged portion of the screen shot of FIG. 4 in accordance with an embodiment of the disclosed principles.

### DETAILED DESCRIPTION

As noted above, although individuals are able to view video and other informational media content available over the internet and other such media viewing outlets, there is no convenient mechanism to allow users to customize and format the video and information in order to display the content that they are most interested in.

With this in mind, the disclosed principles provide a system that can be used to create and share multi-media and other informational media content over a computer network. While the invention lends itself to many variations, certain embodiments will be discussed herein to aid the reader in understanding the attached claims.

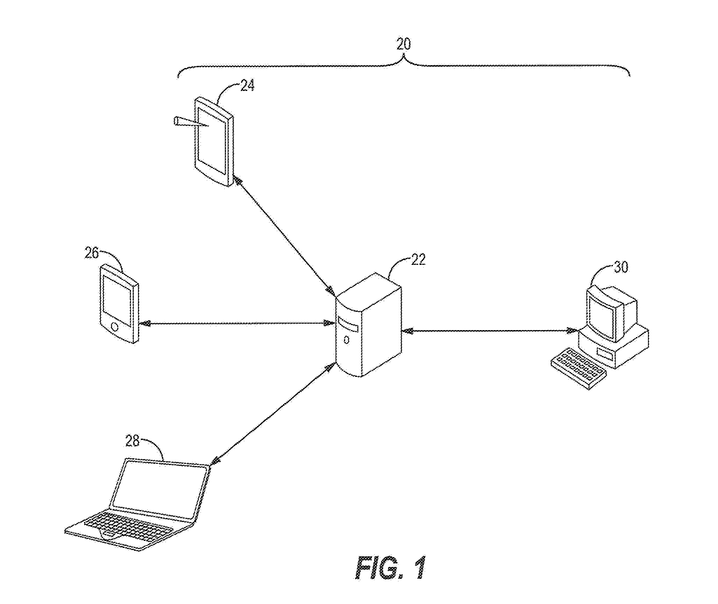

Turning now to a more detailed discussion in conjunction with the attached figures, the techniques of the present disclosure are illustrated as being implemented using suitable computing devices and computer networking equipment. FIG. 1 shows an example of such an environment. In particular, the illustrated example of a computing and network environment 20 includes a server 22 as well as numerous user devices 24, 26, 28 and a curative device 30. It will be appreciated that a greater or lesser number of user and curative devices may be used, depending on the number of users and administrators in the system.

Each of the user devices 24, 26, 28 and the curative device 30 may be a portable or stationary computing device capable of communicating electronically (e.g., via a wired or wireless network). Additionally, each user devices 24, 26, 28 and curative device 30 should have user interface capabilities such that its user may observe information (e.g., on a screen of the device), and may input or otherwise provide information (e.g., via a virtual or physical device key board).

In an embodiment, the collection of user devices 24, 26, and 28 includes one or more of a smartphone device, a laptop device, a desktop PC, a tablet computing device, a smart watch, or other such device. The curative device 30 may also be any of the smartphone, laptop, desktop PC, tablet, smart watch, or other such computing device.

Each of the user devices 24, 26, 28 and curative device 30 has memory, e.g., RAM and ROM, and a processing unit, and executes computer-implemented tasks by retrieving computer-executable instructions from a non-transient computer-readable medium such as one or both of RAM and ROM or other memory structure, and executing the computer-executable instructions on the device processor. Thus, for example, the later flowcharts herein will refer to steps, and it will be appreciated that those steps which are computer-implemented on a device are executed in the above manner.

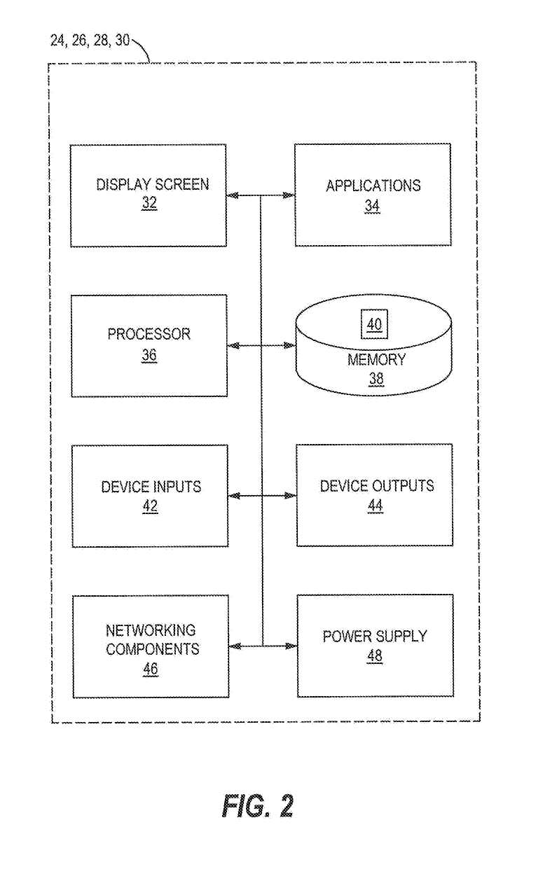

Referring to FIG. 2, an exemplary user device 24, 26, 28 and/or curative device 30 is depicted in schematic form. As described above, each user device 24, 26, 28 and the curative device 30 may access multi-media and other such informational media content that is stored on the server 22. Additionally, the multi-media and other such informational media content may be stored at an alternative location of the computing and network environment 20.

In the illustrated embodiment, the components of the user and curative devices 24, 26, 28, 30 include a display screen 32, applications 34 (e.g. programs), a processor 36, a memory 38 or non-transitory storage medium, one or more device inputs 42, and one or more device outputs 44. The user and curative devices 24, 26, 28, 30 may be a mobile device, such as a smartphone, a laptop computer, a tablet computer (or pad), a smartwatch, an electronic book (eBook reader, or other mobile or personal electronic devices that may be used to communicate wirelessly (or via a fixed link) and allow the user to view and share information). Moreover, the user and curative devices 24, 26, 28, 30 may also be any computer, such as a desktop computer, or processor based device that may use fixed (or wireless) links to communicate with other components and devices.

The display screen 32 may be connected to the processor 36 and memory 38 of the user and curative devices 24, 26, 28, 30. When a user accesses one of the user and curative devices 24, 26, 28, 30, the display screen 32 may visually represent the encoded software of the operating system of the user and curative devices 24, 26, 28, 30 saved within the memory 38. Additionally, the display screen 32 may visually show the applications 34 accessed by the user and stored within the memory 38 of the user and curative devices 24, 26, 28, 30. The display screen 32 may have the added benefit of being operable as a device input 42. As a device input 42, the display screen 32 may respond to the touch of a user or a stylus to allow the user to input information into the user and curative devices 24, 26, 28, 30 regarding the operation of programs or applications 34 stored within the user and curative devices 24, 26, 28, 30.

The processor 36 can be any of a microprocessor, microcomputer, application-specific integrated circuit, or the like. For example, the processor 36 can be implemented by one or more microprocessors or controllers within an integrated circuit design. Similarly, the memory 38 or non-transitory storage medium may reside on the same integrated circuit as the processor 36. The memory 38 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 38 or non-transitory storage medium may include a read only memory (i.e., a hard drive, flash memory or any other desired type of memory device).

The information that is stored by the memory 38 can include program code associated with one or more operating systems or applications 34 as well as informational data. The operating system and applications 34 are typically implemented via executable instructions stored in the non-transitory storage medium of the memory 38 to control basic functions of the user and curative devices 24, 26, 28, 30. These functions may include interaction among various internal components of the user and curative devices 24, 26, 28, 30 and storage and retrieval of applications 34 and data to and from the memory 38.

With respect to the applications 34 stored within the memory 38, these typically utilize the operating system to provide more specific functionality. In an embodiment of the present disclosure, the multi-media metadata management and playback application 40 may be located within the memory 38 of the user and curative devices 24, 26, 28, 30. Many applications 34 stored within the memory 38 may provide standard or required functionality of the user and curative devices 24, 26, 28, 30. In other cases, applications 34 such as those accessed by the multi-media metadata management and playback application 40 of the disclosure provide optional or specialized functionality, and may be supplied by third party vendors.

As stated above the user and curative devices 24, 26, 28, 30 may each have a device input 42 and a device output 44. Examples of the device input 42 and device output 44 may include a touch display screen or a physical keyboard, a stylus, a microphone, a camera, a speaker, wireless interface, infrared interfaces, and/or other input/output interfaces which may be present on each of the user and curative devices 24, 26, 28, 30. A user may input information through the device input 42 which would then be sent to the processor 36 and memory 38 to execute the input information. Furthermore, the device output 44 may produce the required output, either visually or audibly, dependent on the execution of the applications 34 or commands executed by the processor 36 of the user and curative devices 24, 26, 28, and 30.

Furthermore, the user and curative devices 24, 26, 28, 30 may include software and hardware networking components 46 to allow communications to and from the user and curative devices 24, 26, 28, 30. In some embodiments, the user and curative devices 24, 26, 28 and 30 may have one or more wireless access technologies or interfaces, such as a chip or component, to enable each of the user and curative devices 24, 26, 28, 30 to establish a fixed or wireless link to an outside network. For example, each user and curative devices 24, 26, 28, 30 may use the networking components 46 to access and communicate with one another over the outside network. Furthermore, each of the user and curative devices 24, 26, 28, 30 may use the networking components to access and communicate with the server 22 (FIG. 1) or other computing device. Additionally, the user and curative devices 24, 26, 28, 30 may have one or more wireless technology interfaces that may communicate with one or more of the other components of the user and curative devices 24, 26, 28, 30. The wireless technologies and interfaces that may be used by the corresponding components of the user and curative devices 24, 26, 28, 30 may include a Bluetooth interface, an Institute of Electrical or Electronic Engineers (IEEE) 802.11 compliant (or Wi-Fi) wireless interface, a new field communication (NFC) link, an Infrared Data Association interface, a Radio-Frequency identification interface or a radio frequency transponder, a reflection antenna chip, cellular interface, and or any other wireless technology interface that may be applicable to the personal electronic device. These networking components 46 provide wireless networking functionality, although wired networking may additionally or alternatively be supported.

Moreover, a power supply 48, such as a battery or fuel cell, may be included for providing power to the user and curative devices 24, 26, 28, 30 and their components. All or some of the internal components communicate with one another by way of one or more shared or dedicated internal communication links 50, such as an internal bus. Through these internal communication links 50, power and data may be shared between the multiple internal components of the user and curative devices 24, 26, 28, 30.

In an operational setting, the user and curative devices 24, 26, 28, 30 may be programmed such that the processor 36 and memory 38 interact with the other components of the user and curative devices 24, 26, 28, 30 to perform a variety of functions. The processor 36 may communicate with the memory 38 to implement various modules and execute programs for different activities such as launching an application, transferring data, and toggling through various graphical user interface objects representing thumbnail images of executable programs stored within the memory 38.

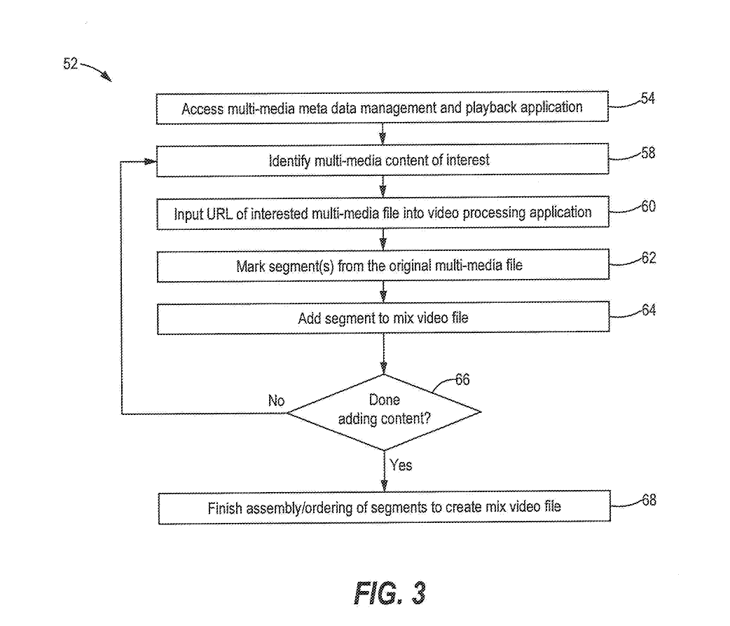

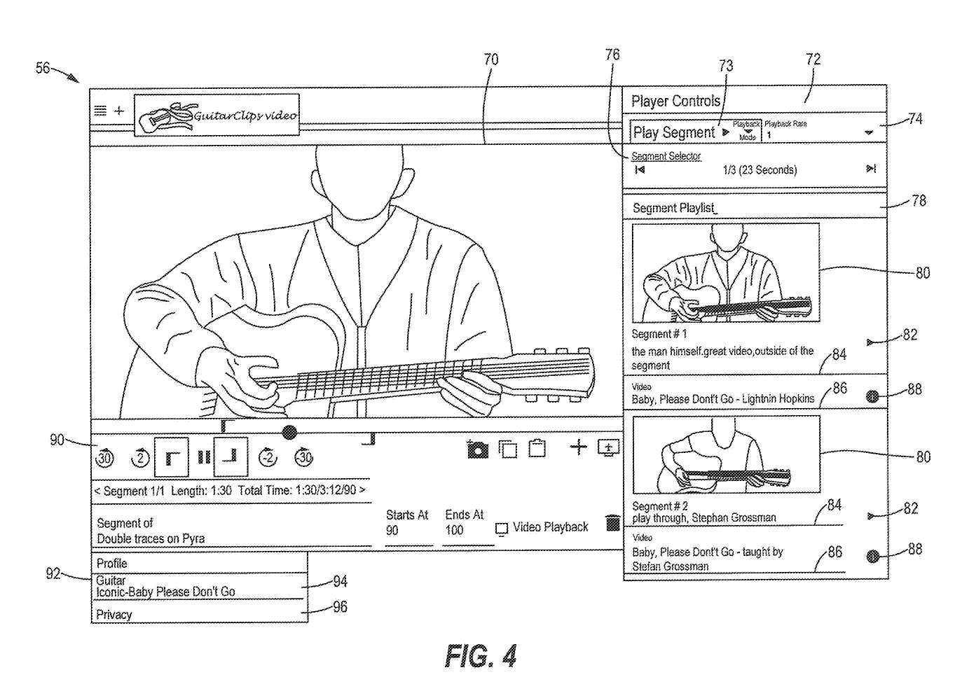

Referring now to FIG. 3, a flow chart of a process 52 for processing and managing multi-media metadata is illustrated. In some embodiments, a curator or other such user may access the multi-media metadata management and playback application 40 to identify and/or mark key segments of interest from one or more video and other multi-media data files. At a first block 54 of the process 52, the curator accesses the multi-media metadata management and playback application 40 over the computing and network environment 20 via the curative device 30. In some embodiments, the multi-media metadata management and playback application 40 may direct the curator to a metadata management and curating home page 56 such as the screenshot shown in FIG. 4. As described above, the curative device 30 may be communicably coupled to the server 22 and one or more user device 24, 26, 28 over the computing and network environment 20. As a result, the user and curative devices 24, 26, 28, 30 may be able to communicate with the server 22 as well as each other device coupled to the computing and network environment 20. In some embodiments, the multi-media metadata management and playback application 40 may be stored locally on the curative device 30. Additionally or alternatively, the multi-media metadata management and playback application 40 is stored on the server 22 and accessed by the curative device 30. As such, the curative device may communicate with the server 22 over the computing and network environment 20 to access the multi-media metadata management and playback application 40. Once the curator or other such user accesses the metadata management and curating home page 56, the curator may be prompted to log in, assuming they have already registered (i.e., created an account on the system). If the curator needs to create an account, the process is similar to traditional processes in that the curator provides some basic information as well as a username and password.

Once the curator has logged in, the multi-media metadata management and playback application 40 may provide several options to the curator or other user such as but not limited to, view multi-media content, search for multi-media content, create a new mix multi-media file and/or curation or other such function. Typically, multi-media content includes video files, audio files, text files, photo files, animation files, and any other such content or combinations thereof. As used herein, the term mix multi-media file is understood to describe a multi-media file created from marking or otherwise identifying a portion of one or more original multi-media files (e.g. You Tube video or other online multi-media content) with metadata markers. Moreover, the mix multi-media file is curated or otherwise managed by identifying one or more segments from the one or more original multi-media files. As such, the interested segments may be marked with metadata, given a unique title, ordered, and configured to be replayed or viewed in a selected format by the user or other interested individual. Furthermore, as used herein, the term segment is understood to describe a portion of an original multi-media file that is selected or otherwise marked by the curator with the metadata marker. The segment may be configured to identify certain multi-media content of interest by the curator. As a result, the curator may use the metadata management and playback application 40 to identify one or more segments of interest and ignore other portions of the original multi-media file that are not of immediate interest. In some embodiments, the segment may be given a unique segment name and has a start time and an end time. As a result, the curator may incorporate the segment (i.e., portion of original multi-media file of interest) into the newly managed or curated mix multi-media file.

In one non-limiting example, if the curator chooses to create a new mix multi-media file, then in a next block 58, the user will identify multi-media content (e.g., video, audio, text, photo) that they wish to mark with the metadata marker (e.g., enhance and condense) and incorporate into the mix multi-media file using the multi-media metadata management and playback application 40. In some embodiments, the original multi-media content may be stored or hosted on the server 20, and the original multi-media content is accessed over the computing and network environment 20. For example, the curator may direct the curative device 30 to access a web site or other video or media content location (i.e., YouTube), and the curator may locate one or more multi-media files that are of interest.

In a next block 60, the curator may input a uniform resource locator (URL), or other such file reference, into the multi-media metadata management and playback application 40. The URL provides a location or other such reference that specifies the location of the original multi-media file of interest on the computing and network environment 20. As mentioned above, the original multi-media file of interest may be stored on a web site (i.e., YouTube) hosted by the server 22 or other computing device coupled to and/or capable of being accessed over the computing and network environment 20. Alternatively, the curative device 30 may download and save the multi-media file of interest onto the memory 38 of the curative device 30.

The curator may utilize one or more curative tools included in the multi-media data management and playback application 40 to mix, enhance and/or edit multi-media content from the original multi-media file of interest. As a result, in a next block 62, the curator uses metadata to mark or otherwise select the multi-media content of interest from the original multi-media file. In one non-limiting example, each segment marked with the metadata marker may be identified with a start time and an ending time of the interested segment or portion of the original multi-media file. For example, the segment which runs from the 1 minute 20 second mark to the 2 minute 5 second mark of the original multi-media file would have the start time entered as 1:20 and the end time entered as 2:05. Additionally, the curator may give the identified segment a unique title or other such identifier which describes the identified segment.

Once the multi-media file of interest has been identified and marked into the interested segments, then in a next block 64 the curator is able to select the one or more specific segments from the original multi-media file that they are interested in. Moreover, the curator is able to manage the new mix multi-media file such that the identified segments can be replayed in a specific order. After the curator is finished selecting the one or more specific segments from the original multi-media file then in a next block 66, the curator may be prompted or otherwise asked whether they are done selecting and marking segments with metadata for the mix multi-media file. If the curator would like to identify and mark additional content for the mix multi-media file then the process 52 may take the curator back to block 58 to identify and mark the additional multi-media content of interest with metadata. In some embodiments, an additional segment may be selected from the current original multi-media file. Alternatively, additional segments may be selected from one or more different original multi-media files. The curator may repeat blocks 58-64 to create additional segments or content to the mix multi-media file.

Once the curator is finished selecting and identifying all of the segments to be included in the mix multi-media file, then in a next block 68, the curator may be directed to finish assembling and/or ordering the selected segments. As described above, the mix multi-media file may contain a single multi-media segment that was identified, marked with the metadata marker and selected from the original multi-media file. Alternatively, the mix multi-media file may include a plurality of multi-media segments which were marked or otherwise chosen from one or more separate original multi-media files. As a result, the curator or other such user may assemble or compile each of the selected multi-media segments to complete the mixing or curation of the new mix multi-media file. Furthermore, during the assembly of selected segments the curator may order or otherwise arrange each of the selected segments such that the mix multi-media file displays the selected segments according to the curative intent of the user.

Once the mix multi-media file is complete, the curator or other such user may post or otherwise make the mix multi-media file available via the multi-media metadata management and playback application 40. As a result, other interested individuals may access the multi-media metadata management and playback application 40 using a user device 24, 26, 28 to view the posted mix multi-media file.

Referring now to FIG. 4, an exemplary metadata management and curating home page 56 is shown. In some embodiments, the curator or other such user of the multi-media metadata management and playback application 40 may access the metadata management and curating home page 56 to create or edit the new mix multi-media file. As can be seen in this exemplary view, the metadata management and curating home page 56 may have a multi-media content viewing screen 70 that displays the selected multi-media file currently being viewed and enhanced by the user of the multi-media metadata management and playback application 40. Furthermore, the original multi-media content being enhanced may be located on a website or other internet location (e.g., You Tube) and the internet address or uniform resource locator (URL) may be input into the metadata management and curating home page 56 so the multi-media content is displayed in the multi-media content viewing screen 70. It will be understood that the metadata management and curating home page 56 may create and save a set of preferences that customize the content and features of interest to the user. As a result, when the curator or user logs into or otherwise accesses the multi-media metadata management and playback application 40, the metadata management and curating home page 56 is displayed according to the previously defined preferences.

The metadata management and curating home page 56 may further include a multi-media playback control 72 that allows the curator to select and control a playback mode 73 for the multi-media content displayed in the multi-media content viewing screen 70. The playback mode 73 may include modes such as but not limited to, mix playback, segment playback, multi-media playback, playlist playback and the like. In one non-limiting example, when the playback mode 73 is set to mix playback the multi-media player plays through segments 1-n, and then loops back to 1 again. Alternatively, when the playback mode 73 is set to segment playback the multi-media player may play and loop the current selected segment. Moreover, if multi-media playback is selected then the multi-media player may play the entire original multi-media file similar to watching a multi-media file on You Tube or other such media player. Furthermore, if the playlist playback is selected then the multi-media player may play multiple mixes that can be ordered on a playlist created by the curator.

The multi-media playback control 72 may allow the curator to customize the playback rate of the multi-media content. For example, the multi-media playback control 72 may include a playback rate control 74 that allows the multi-media content to be played at a slower rate or quicker rate. Additionally, the multi-media playback control 72 may include a segment selector 76 which allows the user to select a specific segment of the multi-media content to view. The segment selector 76 may be configured to display the current segment number that is selected from the total number of segments included in the mix multi-media file or other multi-media content being displayed in the multi-media content viewing screen 70. Additionally, the segment selector may display the time or length of the selected segment. In the example shown in FIG. 4, segment 1 out of a total of 3 segments (i.e., 1/3) is currently selected and segment 1 has a play time or length of 23 seconds. Furthermore, the segment selector 76 may be configured to allow the user to scroll or scan forward and backward through the total number of segments present in the multi-media content. In one non-limiting example, a forward and/or backward arrow can be activated by the user to scroll or scan through the segments to select the desired segment.

As can be further seen, the metadata management and curating home page 56 may also display a mix multi-media segment playlist 78 that includes one or more segment playback screens 80. The mix multi-media segment playlist 78 may display segment information as the user scrolls through the segment selector 76 in the multi-media playback control 72. Generally, the metadata management and curating home page 56 is configured such that the segment playback screen 80 is smaller than the multi-media content viewing screen 70; however other configurations of the metadata management and curating home page 56 are possible. The one or more segment playback screens 80 may be used to play individual segments that are included in the curated multi-media content being edited or viewed on the multi-media metadata management and playback application 40. As a result, the mix multi-media segment playlist 78 may include a play function 82 used to control the playing of the desired segment within the mix multi-media segment playlist 78. Additionally, the mix multi-media segment playlist 78 may have a segment title text box 84 that displays the name or identifier of the selected segment. Furthermore, a multi-media title text box 86 may display the title of the original multi-media content from which the specific segment was selected from. The mix multi-media segment playlist 78 may also include a segment information tab 88 that includes segment information that the curator would like to include about the particular segment.

During mixing or other such enhancing of the multi-media file, the curator may use one or more functions of a multi-media editor bar 90 displayed on the metadata management and curating home page 56 and incorporated with the multi-media metadata management and playback application 40. The multi-media editor bar 90 includes numerous multi-media enhancing tools the curator may employ during curation or other such editing of the multi-media content. Exemplary functions of the multi-media editor bar 90 will be discussed in greater detail below.

An additional feature of the metadata management and curating home page 56 may be a mix multi-media profile editor 92. The mix multi-media profile editor 92 may include a mix file text box 94 where the curator can enter a title for the new mix multi-media file. In some embodiments, the title or text entered into the mix file text box 94 may be displayed on the multi-media content viewing screen 70 when the mix multi-media file is being played or actively edited by the multi-media metadata management and playback application 40. Furthermore, the mix multi-media profile editor 92 may include a privacy setting 96 that the user can control to determine what group of individuals may view and access the mix multi-media content. For example, the privacy setting 96 may be set to make the mix multi-media content available to anyone who is interested. Alternatively, the privacy setting 96 may be set to restrict viewing of the mix multi-media content to a registered group of individuals that have asked for permission to view the curated mix multi-media content.

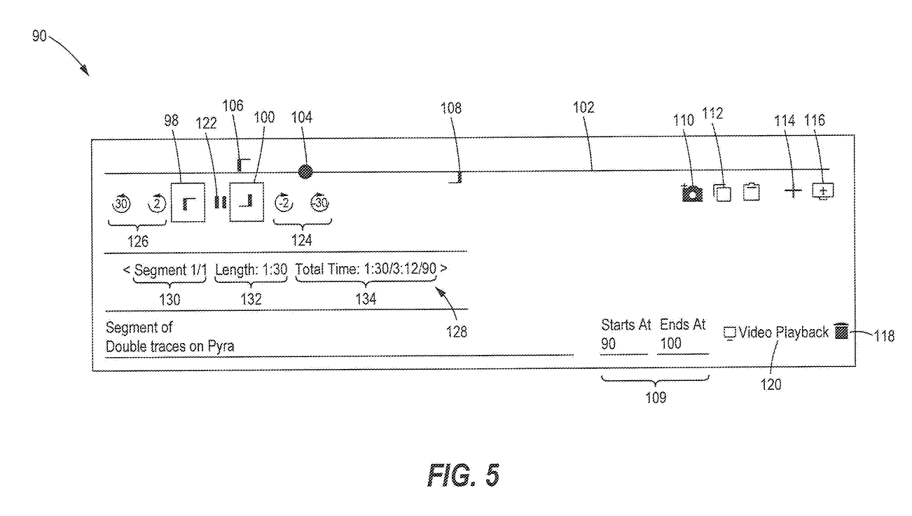

Referring now to FIG. 5 with continued reference to FIG. 4, an enlarged illustration of the multi-media editor bar 90 is shown. The multi-media editor bar 90 may be a portion of the metadata management and curating home page 56 utilized by the curator or user during curation of mix multi-media content. As the name suggests, the multi-media editor bar 90 may have a plurality of multi-media editing tools that are used to perform editing and enhancing tasks such as, creating multi-media segments, deleting multi-media segments, adding text or images to segments, and other such editing tasks. In some embodiments, the multi-media editor bar 90 may include an incut selector 98 and an outcut selector 100. Additionally, the multi-media editor bar 90 may have a multi-media playback progress bar 102 and multi-media position marker 104. In some embodiments, the multi-media playback progress bar 102 illustrates the playback length of the current multi-media file being edited by the multi-media metadata management and playback application 40. Furthermore, the multi-media position marker 104 shows the current location of the multi-media that is being displayed in the multi-media content viewing screen 70 of the metadata management and curating home page 56.

The incut selector 98 and the outcut selector 100 may each be used by the curator to mark or identify the start point or beginning and the end point or ending of a multi-media segment from the original multi-media file. Moreover, the incut selector 98 and the outcut selector 100 may use metadata markers to mark the beginning and end of the interested multi-media segment portion from the original multi-media file. In other words, each multi-media segment may have an incut portion, marked using the incut selector 98, and the incut portion is the starting point for playback of the interested content from the original multi-media file. Additionally, each multi-media segment may have an outcut portion, marked using the outcut selector 100, and the outcut portion is the end point for playback of the interested content from the original multi-media file.

For example, the curator may activate the incut selector 98 to mark and identify the start of the multi-media segment and activate the outcut selector 100 to mark and identify the end of the multi-media segment. This may allow the curator to ignore certain multi-media content in the original multi-media file such that the interested segment only displays the interested content. In some embodiments, the start of the multi-media segment may be illustrated by the placement of an incut icon 106 at the marked and identified position along the multi-media playback progress bar 102. Similarly, the end of the selected multi-media segment may be illustrated by the placement of an outcut icon 108 at the marked and identified position along the multi-media playback progress bar 102. As further illustrated in FIG. 5, the incut icon 106 and outcut icon 108 may identify the desired segment which is only a portion of the original multi-media file. As a result, the curator may mark and identify the specific multi-media content they are interested in to include in the mix multi-media file.

Alternatively, the curator may wish to mark or otherwise set the start point (i.e., incut icon 106) and end point (i.e., outcut icon 108) of the segment by using time points 109. In one non-limiting example, the curator enters the start time at time point 109 (i.e., incut icon 106) for the segment as being 90 seconds and the end time at time point 109 (i.e., outcut icon 108) being 100 seconds; however, other times may be provided depending on the length or location of the desired multi-media segment.

The multi-media editor bar 90 may also include an image selector 110 which allows the curator to select an image or other such file to serve as a thumbnail identifier for the video segment. In one non-limiting example, the image selector 110 may be used to select a screen shot or other image from the original multi-media file that a particular segment is being created from. However, the image selector 110 may be used to select an image from an alternative source to use as the thumbnail identifier for the multi-media segment.

Furthermore, the multi-media editor bar 90 may be configured with a segment cut and paste selector 112. The curator may utilize the cut and paste selector 112 to add, remove, or reorder segments to a mix multi-media file. For example, the cut and paste selector 112 may be used to cut or copy a segment formed from the original (i.e., full length) multi-media file and paste or insert the segment into the mix multi-media file. Additionally, the cut and paste selector 112 may be used to reorder or otherwise arrange segments within the mix multi-media file by cutting and pasting segments into the desired order.

Some embodiments of the multi-media editor bar 90 may also include one or more add segment selectors. For example, an add segment from existing multi-media selector 114 may be selected or otherwise used to create an additional multi-media segment from the currently selected original (i.e., full length) multi-media file being enhanced in the multi-media metadata management and playback application 40. Alternatively, an add segment from different multi-media selector 116 may be selected or otherwise used to create an additional multi-media segment from a different original multi-media file to be edited in the multi-media metadata management and playback application 40. In some embodiments, selecting the add segment from different multi-media selector 116 will ask the user to input the URL or other file location for the different multi-media file. As a result, the multi-media content viewing screen 70 may display the different multi-media file and the user may identify the segment of the multi-media file to be included into the mix multi-media file.

Moreover, the multi-media editor bar 90 may include a delete segment selector 118 configured to allow the user to identify a segment to be removed or deleted from the mix multi-media file. Additionally, a playback mode selector 120 may be incorporated into the multi-media editor bar 90. The user may use the playback mode selector 120 to change or toggle playback modes of the metadata management and curating home page 56. In one non-limiting example, the curator or user can use the playback mode selector 120 to choose between playback modes such as video multi-media playback, segment playback, or other such modes. When the playback mode selector 120 is set to multi-media playback, the entire original multi-media file being displayed by the metadata management and curating home page 56 may be played when a multi-media playback selector 122 is activated. Alternatively, when the playback mode selector 120 is set to segment playback, the multi-media segment defined by the incut icon 106 and outcut icon 108 is played when the multi-media playback selector 122 is activated.

The multi-media playback selector 122 may be configured to play, pause, or stop the playback of the multi-media file or multi-media segment. Additionally, a forward skip selector 124 and a reverse skip selector 126 may be incorporated with the multi-media playback selector 122. In some embodiments, the forward and reverse skip selector 124, 126 may include a plurality of selectors that allow the playback of the multi-media file to skip forward and/or skip backward a pre-determined amount of time. In one non-limiting example, the forward and reverse skip selector 124, 126 may each include a 2 second skip and a 30 second skip selector. As a result, a user may skip forward or backward in 2 second and/or 30 second increments. It will be understood that the user may configure the forward and reverse skip selector 124, 126 with different skip increments, as desired.

Additionally, the multi-media editor bar 90 may include a multi-media content dashboard 128 that tracks and displays a variety of multi-media content playback information. In one non-limiting example, the multi-media content dashboard 128 displays segment information 130, segment length 132, and total multi-media time 134. The segment information 130 displays the current segment selected and/or displayed by the metadata management and curating home page 56 and the total number of segments included in the mix multi-media file. In the illustrated example, the segment information 130 displays segment 1 out of 1 total segment (e.g., 1/1). Additionally, the segment length 132 may be configured to provide the playback length in minutes and seconds (e.g., 1:30) of the selected segment. Furthermore, the total multi-media time 134 may display the current position in multi-media, total length of the multi-media, and current multi-media position in seconds (e.g., 1:30/3:12/90).

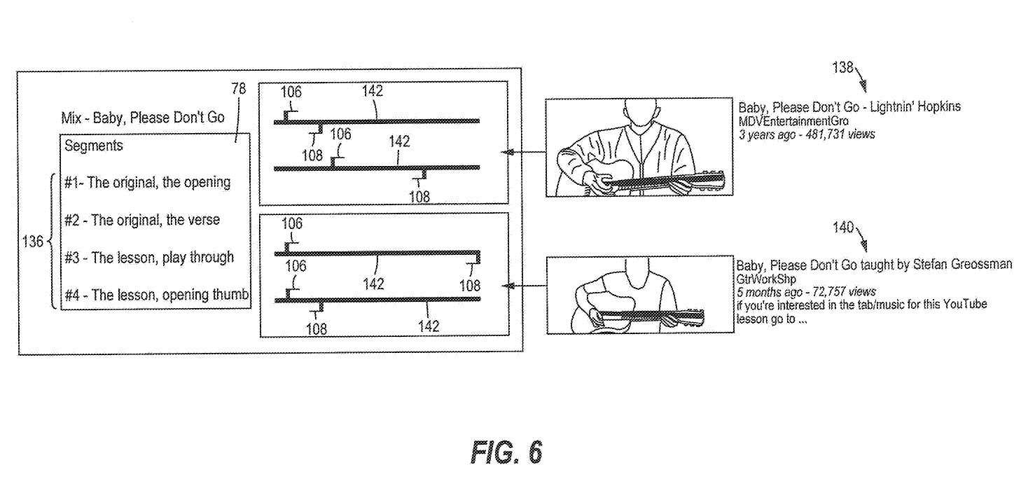

Referring to FIG. 6 with continued reference to FIGS. 4 and 5, an exemplary mix multi-media segment playlist 78 is illustrated. The mix multi-media segment playlist 78 may include one or more multi-media segments 136 that are included in the curated mix multi-media file. As discussed above, the mix multi-media file is understood to describe a multi-media file created from marking or otherwise identifying a portion of one or more original multi-media files (e.g. You Tube video or other online multi-media content) with one or more metadata markers. Moreover, the mix multi-media file may be curated or otherwise created by identifying one or more segments from one or more original multi-media files that contain multi-media content of interest. As such, the mix multi-media segment playlist 78 may mark or otherwise select a plurality of multi-media segments 136 which may be sourced from different original source multi-media files 138, 140. Alternatively, the mix multi-media segment playlist 78 may be sourced from a single original multi-media file 138, 140 and one or more multi-media segments 136 may be marked or otherwise selected to playback only the desired content from the original source multi-media file 138, 140.

In the non-limiting example illustrated in FIG. 6, the mix multi-media segment playlist 78 includes four (i.e., #1-4) multi-media segments 136 that are marked from two different original source multi-media files 138, 140. For example, two multi-media segments 136 are marked from a first original source multi-media file 138 and two multi-media segments 136 are marked from a second original source multi-media file 140. However, as discussed above, the mix multi-media segment playlist 78 may include a different number (e.g., larger or smaller) of multi-media segments 136 taken from one or more original source multi-media files 138, 140. Furthermore, the mix multi-media segment playlist 78 may display a segment progress bar 142 for each multi-media segment 136, similar to the multi-media playback progress bar 102 shown in FIG. 5.

The segment progress bar 142 may illustrate the length or runtime of the original source multi-media files 138, 140. Additionally, the multi-media segment 136 may mark or otherwise identify only the interested portion of the original source multi-media files 138, 140. For example, as illustrated in the multi-media segment 136 labeled #1-4, the segment progress bar 142 displays the incut icon 106 and the outcut icon 108 to mark the interested portion of the original source multi-media file 138. As discussed above, the incut icon 106 represents a metadata marker placed in the original source multi-media file 138, 140 which marks the start point for playback of the multi-media segment 136. Additionally, the outcut icon 108 represents a metadata marker placed in the original source multi-media file 138, 140 which marks the end point for the playback of the multi-media segment 136.

It will be appreciated that a system and method for improved community activity and resource coordination have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof

We claim:

1. A system for curating a multi-media made available over a computer network, the system comprising:
a server hosting a metadata management application, the metadata management application configured to retrieve an original multi-media file from a network location on the computer network;
an electronic computing device communicably coupled with the server and the metadata management application, the metadata management application programmed to receive one or more input commands communicated from the electronic computing device, wherein the metadata management application is programed to mark the original multi-media file with a first metadata marker and a second metadata marker based on the one or more input commands received from the curative electronic computing device.

2. The system of claim 1, wherein the first metadata marker is a starting position and the second metadata marker is an ending position to a segment marked from the original multi-media file.

3. The system of claim 1, wherein the metadata management application is further programmed to retrieve two or more different original multi-media files from the network location.

4. The system of claim 3, wherein the metadata management application is programmed to mark each of the two or more different original multi-media files with a different first metadata marker and a different second metadata marker.

5. The system of claim 4, wherein each of the different first metadata marker is a starting positon and each of the different second metadata marker is an ending position to a different segment marked from each of the different original multi-media files.

6. A method of curating a multi-media file using a metadata management application, the method comprising:
accessing a server over a computer network, the server hosting the metadata management application;
identifying an original multi-media file at a network location over the computer network;
inputting a URL for the original multi-media file into the metadata management application;
identifying a segment from the original multi-media file formed between a first metadata marker and a second metadata marker;
inputting a first input command into the metadata management application, the first input command marking the segment of the original multi-media file with the first metadata marker;
inputting a second input command into the metadata management application, the second input command marking the segment of the original multi-media file with the second metadata marker; and
finalizing the segment identified from the original multi-media file such that the metadata management application displays the segment.

7. The method of claim 6, wherein marking the original multi-media file with the first metadata marker includes setting a starting position of the segment and marking the original multi-media file with the second metadata marker includes setting an ending position of the segment.

8. The method of claim 6, wherein identifying the original multi-media file includes identifying two or more different original multi-media files over the computer network.

9. The method of claim 8, wherein inputting the first input command includes marking the segment from each of the different original multi-media files with a different first metadata marker and a different second metadata marker.

10. The method of claim 9, wherein each of the different first metadata markers indicate a different starting position for each segment of the different original multi-media files and each of the different second metadata markers indicates a different ending position for each segment of the different multi-media files.

11. A multi-media management application accessed by an electronic computing device to curate a mix multi-media file, the multi-media management application comprising:
an application home page displayed by the electronic computing device, the application home page including a content viewing screen that displays an original multi-media file selected to be viewed and enhanced by the multi-media management application;
a multi-media editor bar displayed on the application home page, the multi-media editor bar includes an incut selector and an outcut selector, the incut selector and the outcut selector define a segment to be included in the mix multi-media file from the original multi-media file;
a multi-media playback control included on the application home page, the multi-media playback control includes a plurality of modes that control the playback of the content viewing screen; and
a multi-media profile editor displayed on the application home page, the multi-media profile editor including a profile text box for inputting a title for the segment defined from the original multi-media file.

12. The multi-media management application of claim 11, wherein the incut selector identifies a start point of the segment with a first metadata marker and the outcut selector identifies an end point of the segment with a second metadata marker.

13. The multi-media management application of claim 11, wherein the multi-media editor bar further includes an add segment selector to define an additional segment from the original multi-media file into the mix multi-media file.

14. The multi-media management application of claim 13, wherein the add segment selector defines the additional segment to be included in the mix multi-media file from a different original multi-media file.

15. The multi-media management application of claim 13, wherein the multi-media editor bar includes a segment cut and paste selector used to reorder the segment and the additional segment included in the mix multi-media file.

16. The multi-media management application of claim 13, wherein the multi-media editor bar includes a delete segment selector to remove one of the segment and the additional segment from the mix multi-media file.

17. The multi-media management application of claim 11, wherein the multi-media editor bar includes a multi-media content dashboard that displays information related to the mix multi-media file, and wherein the multi-media content dashboard includes a segment information, a segment length and a total multi-media time.

18. The multi-media management application of claim 11, wherein the plurality of modes of the multi-media playback control include a mix playback mode, a segment playback mode, a multi-media playback mode and a playlist playback mode.

19. The multi-media management application of claim 11, wherein the mix multi-media file includes a plurality of segments and the multi-media playback control further includes a segment selector for selecting a specific segment from the plurality of segments included in the mix multi-media file to view in the content viewing screen.

20. The multi-media management application of claim 19, wherein the application home page displays a mix multi-media segment playlist including the plurality of segments defined from one or more original multi-media files.
